(19) United States
(12) Patent Application Publication
(10) Pub. No.: US 2025/0030314 A1
(43) Pub. Date: Jan. 23, 2025

(54) INTEGRATED POWER ELECTRONICS FOR MICROTURBINE GENERATOR

(71) Applicant: BorgWarner Inc., Auburn Hills, MI (US)

(72) Inventor: Lathom Louco, Arden, NC (US)

(21) Appl. No.: 18/224,331

(22) Filed: Jul. 20, 2023

(51) Int. Cl. H02K 7/18; H02K 7/00; H02K 9/19; H02P 27/06

(52) U.S. Cl. CPC H02K 7/1823; H02K 9/19; H02P 27/06

(57) ABSTRACT

A microturbine generator including a power electronics assembly, including a motor controller and a DC/AC inverter mounted on a PCB, configured to electrically couple to a turbine assembly having a turbine and an electrical generator coupled via a shaft; and a cooling plate directly abutting the motor controller and the DC/AC inverter, wherein the power electronics assembly and cooling plate are enclosed within a housing.

### TECHNICAL FIELD

The present application relates to microturbine generators and, more particularly, to power electronics that control microturbine generators.

### BACKGROUND

As the world becomes increasingly reliant on the supply of electricity, efforts continue to ameliorate interruptions of the supply. Often, generators use an output shaft of an internal combustion engine. But sometimes, due to size and efficiency issues, this may be impracticable. Other types of power generation exist, such as a microturbine generator (MTG). The MTG typically includes a turbine and, optionally, a compressor coupled via a shaft to a rotor within a stator. A combustible gas can be burned to yield an exhaust that is communicated to the turbine thereby angularly displacing the rotor relative to the stator. This relative motion can generate electricity. However, the conversion of mechanical work carried out by the turbine/compressor into electricity that is usable by an AC grid or building involves different types of power electronics as well as complex control of those electronics. It would be helpful to arrange the power electronics more efficiently.

### SUMMARY

In one implementation, a microturbine generator includes a power electronics assembly, including a motor controller and a bidirectional DC/AC inverter mounted on a PCB, configured to electrically couple to a turbine assembly having a turbine and an electrical generator coupled via a shaft; and a cooling plate directly abutting the motor controller and the bidirectional DC/AC inverter, wherein the power electronics assembly and cooling plate are enclosed within a housing.

In another implementation, a microturbine generator includes a turbine assembly including a turbine coupled to a shaft; an electrical generator coupled to the shaft; a power electronics assembly including a motor controller and a bidirectional DC/AC inverter mounted on a PCB coupled to the turbine assembly; a cooling plate abutting the motor controller and the bidirectional DC/AC inverter; and modular energy storage electrically connected to the power electronics assembly via a DC bus.

### BRIEF DESCRIPTION OF THE DRAWINGS

FIG. 1 is a block diagram depicting an implementation of a microturbine generator (MTG) with power electronics; and

FIG. 2 is a cross-sectional view depicting an implementation of the power electronics assembly;

FIG. 3 is a perspective view depicting an implementation of the power electronics assembly;

FIG. 4 is a cross-sectional view depicting another implementation of the power electronics assembly; and

FIG. 5 is a cross-sectional view depicting another implementation of the power electronics assembly.

### DETAILED DESCRIPTION

A microturbine generator (MTG) can include a turbine connected to a common shaft. The shaft can also be mechanically linked to a rotor concentrically positioned within a stator collectively forming an electrical generator. Exhaust gas created through combustion can be supplied to the turbine so as to spin the turbine, as well as the rotor. The rotation of the rotor can generate alternating current (AC) electrical power. MTGs having a common shaft linking the turbine and the rotor can include a power electronics assembly that combines multiple functions into a common housing. For example, the power electronics assembly can include a motor controller that can rectify AC electrical current created by the electrical generator, a bidirectional DC/AC inverter, and one or more modular energy storage modules sharing a common DC bus. A cooling circuit can directly abut the inverter, the DC/AC inverter, and the modular energy storage in the common housing. The quantity of modular energy storage units, also referred to as bulk capacitance or batteries, can be increased or decreased depending on the load electrically connected to the MTG. The integration of the inverter, DC/AC inverter, and the modular energy storage can eliminate cables, lower impedances, use an integrated cooling circuit, eliminate cables, modularly configure energy storage, in a more compact arrangement, which can increase system power density.

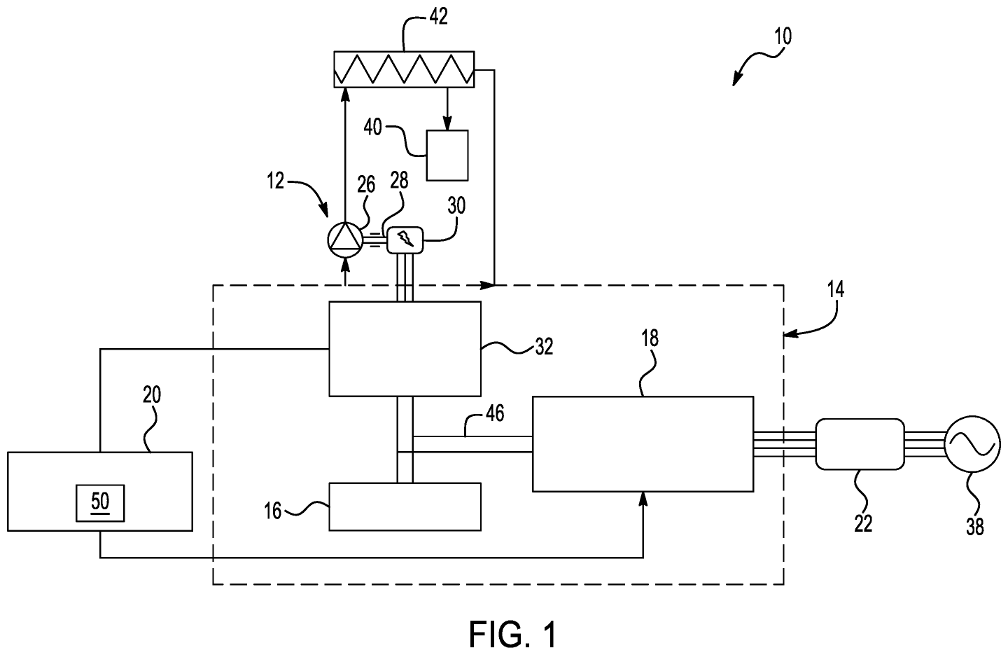

Turning to FIG. 1, an implementation of a microturbine generator (MTG) 10 is shown. The microturbine includes a turbine assembly 12 and a power electronics assembly 14. The power electronics assembly 14 includes modular energy storage 16, a DC/AC inverter 18, and a master controller 20 within a common housing. The turbine assembly 12 can also include a grid-tie contactor 22 that controls the electrical connection between the MTG 10 and an electrical grid 24. The turbine assembly 12 can include a turbine 24 linked to a common shaft 28. In this implementation, the turbine 24 can be a radial turbine such that exhaust gas is supplied from a direction that is normal to the axis of turbine rotation. The exhaust gas flows over the blades of the turbine 24 and impart rotational energy or torque on the common shaft 28. The common shaft 28 can also couple with a rotor of a rotating electrical machine that acts as an electrical generator 30 when the rotor is angularly displaced with respect to the stator. The generator 30 can output three-phase AC electrical current and voltage while the rotor is rotating relative to the stator. The MTG 10 having the electrical generator 30 can be rated between 100 kilowatts (kW) to 1 megawatt (MW). The electrical generator 30 can be electrically connected to the power electronics assembly 14 such that the AC electrical current can be received by the power electronics assembly 14. The rotor of the electrical generator 30 can be operated at both lower and higher speeds. For instance, the electrical generator 30 can operate both above and below 20,000 RPM rotor speeds.

The power electronics assembly 14 can include a motor controller 32 having active or passive electrical components that rectify the AC electrical current generated by the electrical generator 30 into DC electrical current. The active electrical components can include, for example, bipolar junction transistors (BJT) or metal oxide semiconductor field effect transistors (MOSFETs) and passive electrical components can include diodes. The electrical components can be mounted on a printed circuit board (PCB) 34. The motor controller 32 can operate in open-loop or closed loop speed control or torque control modes. The motor controller 32 can use control techniques such as sine-tracking, space vector modulation, or sensorless control. The power electronics can be configured in any one of a number of different ways. For example, different aspects of the power electronics assembly, such as the motor controller or the DC/AC inverter, can use a two-level or a multilevel hard-switched architecture, an interleaved multi-phase architecture, or a soft-switching architecture. The modular energy storage 16 can be detachably coupled to the power electronics assembly 14. The modular energy storage 16 can include discrete modules 36 containing bulk capacitance or other energy storage mechanism. In one implementation, each energy storage module 36 can include electrical connections that detachably couple and electrically connect the energy storage module 36 to the power electronics assembly 14. The quantity of energy storage modules 36 can be chosen based on the load or demand of the electrical grid connected to the MTG 10. For instance, the number of energy storage modules 36 can be within a range of (1:n). In one implementation, the number of modules could be as many as 10 and each module could be 10-200 kWh. However, other values of modules and capacitance are possible. If the demand from the load falls, then the excess electrical energy generated by the electrical generator 30 can be absorbed by the energy storage modules 36. As the demand changes, so too can the quantity of energy storage modules 36.

The DC electrical current can be supplied to the DC/AC inverter 18, which inverts the current into AC electrical current supplied to the load or an electrical grid 24. In one implementation, the DC/AC inverter 18 can include a plurality of switches that inverts the DC electrical current into AC electrical current at an output frequency of 50-60 Hz. The inverted AC electrical current can then be provided to the electrical grid 38 or to the load. In some implementations, the DC/AC inverter 18 can be bi-directional such that electrical current can be received from the electrical grid 38, rectified into DC electrical current, and stored in the modular energy storage 16. The grid-tie contactor 22 can selectively connect the MTG 10 to the electrical grid 38. In one implementation, the grid-tie contactor 22 can be a gate-controlled switch that is selectively opened and closed.

The master controller 20 can control the operation of the power electronics assembly 14, including the motor controller 32 and the DC/AC inverter 18. The master controller 20 can include one or more microprocessors 50 that execute computer readable code and are electrically connected to the gates of switches in the motor controller 32 and the DC/AC inverter 18. For example, the master controller 20 can selectively render MOSFETs in the power electronics assembly 14 conductive as part of rectifying AC electrical current. Similarly, the master controller 20 can selectively render MOSFETs in the DC/AC inverter 18 conductive as part of converting DC electrical current into AC electrical current.

A combustor 40 can burn a fuel supplied by a fuel source 28. The fuel can exist in any one of a variety of forms, such as compressed natural gas, propane, or diesel fuel. The byproduct of the combustion is an exhaust gas that is supplied to the turbine assembly 12. As noted above, the turbine 24 rotates in response to the flow of exhaust gas over the turbine 24. The common shaft 28 rotates the rotor relative to the stator creating AC electrical current from the generator 30. Heat is a byproduct of MTG operations. The MTG 10 can optionally include a recuperator 42 that is heated by MTG operations and heats the air before supplying it to the combustor 42.

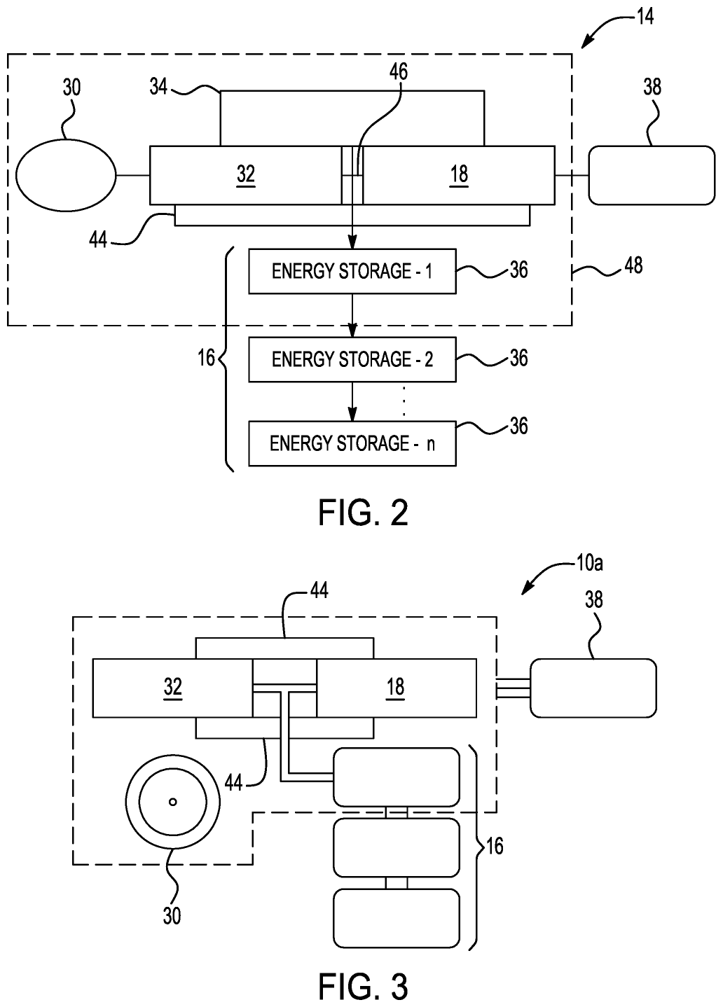

FIGS. 2-3 depicts an implementation of a power electronics assembly 14. The power electronics assembly 14 includes a PCB 34 that, on one side, carries electrical components implementing the motor controller 32 as well as the DC/AC inverter 18. A cooling plate 44 can be positioned in confrontation with the PCB 34 such that the plate 44 directly abuts the electrical components. The modular energy storage 16 can also abut an opposite side of the cooling plate 44 such that one cooling circuit cools the motor controller 32, the DC/AC inverter 18, and the storage 16. The cooling plate 44 can receive fluid within a manifold and communicate the fluid to an externally-located heat exchanger (not shown). In one implementation, the fluid is propylene glycol (PG) but in another implementation the fluid could be a water-ethylene-glycol (WEG) mixture. In other implementations, the fluid can be a lubricant, such as motor oil. The modular energy storage 16 can include a plurality of discrete energy storage modules 36 that are individually electrically linked to the assembly 14 via a common DC bus 46. The energy storage modules 36 can each include bulk capacitance and be individually detachable from the DC bus 46. The components of the power electronics assembly 14 can be enclosed within a common housing 48. The housing 48 can be formed from a variety of different materials, such as molded plastic or aluminum. The power electronics assembly 14 can be electrically linked to the electrical grid 38.

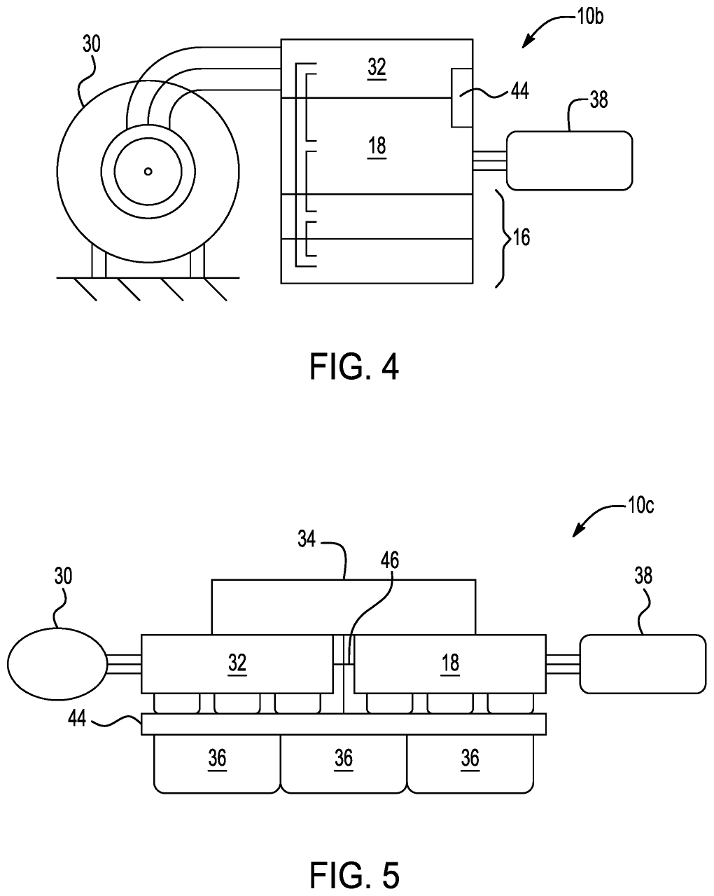

Other arrangements of components in the power electronics assembly are possible. For example, FIG. 3 depicts a stack-up of components comprising an MTG 10a. The motor controller 32 and the DC/AC inverter 18 can be placed on one side of the PCB 34. The cooling plate 44 can be positioned so that it abuts an opposite side of the PCB 34 and the electrical generator 30. The modular energy storage 16 can also abut the cooling plate 44 as well as the electrical generator 30. In another implementation shown in FIG. 4, the MTG 10b can be configured in a linear stack-up of components. For example, the motor controller 32 and the DC/AC inverter 18 can be positioned on opposite sides of the cooling plate 44. The modular energy storage 16 can be coupled to the DC/AC inverter 18.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A microturbine generator, comprising:
a power electronics assembly, including a motor controller and a bidirectional DC/AC inverter mounted on a PCB, configured to electrically couple to a turbine assembly having a turbine and an electrical generator coupled via a shaft; and
a cooling plate directly abutting the motor controller and the bidirectional DC/AC inverter, wherein the power electronics assembly and cooling plate are enclosed within a housing.

2. The microturbine generator recited in claim 1, further comprising a modular energy storage system electrically connected to the power electronics assembly via a DC bus.

3. The microturbine generator recited in claim 2, wherein the modular energy storage system includes one or more capacitors or batteries

4. The microturbine generator recited in claim 1, further comprising a master controller electrically connected to the power electronics assembly.

5. The microturbine generator recited in claim 1, further comprising a combustor and a recuperator.

6. The microturbine generator recited in claim 1, wherein the electrical generator has an output rating between 100 kilowatts and 1 megawatt.

7. The microturbine generator recited in claim 1, wherein the cooling plate is configured to receive a liquid comprising a mixture of propylene glycol (PG).

8. A microturbine generator, comprising:
a turbine assembly including a turbine coupled to a shaft;
an electrical generator coupled to the shaft;
a power electronics assembly including a motor controller and a DC/AC inverter mounted on a PCB coupled to the turbine assembly;
a cooling plate abutting the motor controller and the DC/AC inverter; and
modular energy storage electrically connected to the power electronics assembly via a DC bus.

9. The microturbine generator recited in claim 8, further comprising a master controller electrically connected to the power electronics assembly.

10. The microturbine generator recited in claim 9, wherein the modular energy storage includes one or more capacitors.

11. The microturbine generator recited in claim 8, further comprising a combustor and a recuperator.

12. The microturbine generator recited in claim 8, wherein the electrical generator has an output rating between 100 kilowatts and 1 megawatt.

13. The microturbine generator recited in claim 8 wherein the cooling plate is configured to receive a liquid comprising a mixture of propylene glycol (PG).
